(19) United States
(12) Patent Application Publication
(10) Pub. No.: US 2014/0178849 A1
(43) Pub. Date: Jun. 26, 2014

(54) COMPUTER-ASSISTED LEARNING STRUCTURE FOR VERY YOUNG CHILDREN

(71) Applicant: Dan Dan YANG, Ottawa (CA)

(72) Inventor: Dan Dan YANG, Ottawa (CA)

(21) Appl. No.: 13/726,311

(22) Filed: Dec. 24, 2012

(51) Int. Cl. G09B 7/06

(52) U.S. Cl. CPC G09B 7/06
USPC 434/362

(57) ABSTRACT

Systems, methods, and devices relating to an educational system for children as young as a few months old. The system has different modules which are geared towards different educational aims. Each module teaches a different educational area with the areas ranging from science, math, history, social interaction. The system provides a structured approach such that the child user is tasked with a single module to be completed per month. At the end of a predetermined period, a test module may be completed with assistance from an adult to test the child's retention of the lessons. The various lessons are structured as playful, fun activities with colorful icons, fun sounds, and varying degrees of complexity.

### TECHNICAL FIELD

The present invention relates to education of the very young children with computer assistance. More specifically, the present invention relates to methods for providing education to young individuals.

### BACKGROUND OF THE INVENTION

The revolution in computer technology and the increasing use of handheld computer devices such as tablets have allowed people to take their computing devices wherever they go. It has also led to an increase in younger people using such devices. There is anecdotal evidence that young children very easily adapt to the touch interface of today's tablets and smartphones.

However, there is evidence that young children may not be able to gain knowledge or skills systematically by using these smart devices unless they follow a learning structure. Such a properly designed learning structure may be helpful in developing the user's skills such as mathematical or language skills.

Learning structure typically exists for children who are of school age. At these ages, children are typically in classes which follow a standard based curriculum. However, recent developmental science has uncovered that when a child is exposed to a variety of knowledge subjects before the age of 5, there is a significant impact on the child's success both in schools and after graduation.

Currently, there are structured learning environments such as Montessori schools which offer structured learning for children under the age of 5. However, the costs associated with sending a child to a private school such as Montessori can be very high and a majority of families cannot afford these costs.

There is therefore a need for a learning structure that can be implemented at very low cost, with which home based caregivers (e.g. parents, nannies, daycare center operators, etc.) can easily follow. Such a learning structure can thus benefit a much larger number of children and can prepare them for formal school learning.

### SUMMARY OF INVENTION

The present invention provides systems, methods, and devices relating to an educational system for children as young as a few months old. The system is structured with different modules which are geared towards different educational aims. They are integrated to provide a thorough experience covering various aspects of a young developing mind. Each module teaches a different educational area with the areas ranging from science, math, language, knowledge about the world, and social interactions.

It should be noted that, due to the young age of the child, the knowledge and skill gain shall be incremental from the modules, yet will build on one another. The various modules are thus designed and geared towards the child or user's age and cognitive capability. The early or lower level modules provide a base knowledge skill level that upper or higher level modules build upon. Other modules similarly build upon the skills and knowledge taught by modules which have been completed by the child user. Each module is therefore designed for a child's specific age and cognitive capability and each module can be scheduled for completion by a specific age/month of the user.

The system is designed to be presented to the child user using a playful computer game format running on tablet computers or smart phones. The computer game format provides a format accessible to the young child. As well, the format provides a means by which the young child will not only be able to access various educational lessons, tasks, and activities but will have fun and enjoyment while doing so. The fun aspect of the computer game aspect of the format also makes the child want to use the system. The young child will therefore enjoy playing and using the system. While doing so, the child user increases his or her skills and knowledge as the targeted lessons and activities are built into the play of the computer game format.

Compared to existing software such as learning apps from various providers, the present invention's modules and lessons, always under the format of games, are inter-connected as lower level learning is required before starting higher level lessons. The modules have built-in objectives with targeted knowledge and skill gain. Continuous and unobtrusive assessment is part of the structure. In other words, the learning structure part of the invention contains objectives covering various aspects of a child's intellectual needs, uses lessons and activities which are disguised as games, and uses assessment schemes, similarly disguised as games, that have been adapted for the very young of age.

The different modules are organized in a ladder configuration such that, preferably, higher level modules can only be accessed by the user once the lower level modules have been completed. The various modules which address different subject areas may be distributed across different time frames such that a user need not be confronted with modules addressing the same subject matter in multiple successive months. As noted above, the various modules may have lessons, tasks, and activities that build upon skills and knowledge which have already been developed and nurtured in the young user by previously completed modules.

To track the child user's progress and performance, every time the child user uses the system, his or her performance can be stored in a database. The database can then be mined for the user's progress and capabilities based on his or her performance data. The database can store various aspects of the child user's performance in using the system including which questions/tasks were successfully completed, which questions/tasks were not successfully completed, how long it took to complete a question/task, the reason or reasons why a particular user response was considered wrong, and which modules still need to be completed.

To ensure that the tasks taken on by the young user in each module is useful, each module is provided with specific learning objectives that are proper to not only the user's age but also to the task given. These tasks can take the form of what are essentially lessons that teach the user various skills, knowledge, and experiences that are geared towards enhancing the user's intellectual needs and which would assist the user in understanding how the world functions. To assist in helping the user complete the tasks or lessons, each module provides the lessons in the form of fun, interactive games, designed and well-suited for the user's specific age.

As an additional benefit to the user, the tasks and lessons are designed to be interconnected across different modules such that one module's tasks may inter-connect and be complementary or be an adjunct to another module's tasks. As well, the tasks in the various modules are designed to increase the user's mental, verbal, and social skills such that the user's preparedness for conventional school learning is increased.

One major advantage of the present invention is that it can be used by parents and caregivers to prepare a child for regular schooling using the built-in structure. The system's predetermined curriculum provides a structure that can be followed by the caregiver/adult to guide the child user's activities and use of the system. No longer would caregivers and parents wonder what subject or skill should be taught next in the preschooler's development as the system predetermines the development of the child's skills. The parent or caregiver thus has a framework to work with but can still control the speed and intensity at which the user uses the system. The built-in structure or educational framework provides the child user with a varied background and skill development in skills and knowledge that, as noted above, would prepare the child for regular schooling. Depending on the implementation, the timing of the scheduled completion of one module, containing at least one lesson and/or activity can be one per month, one per week, or one per given predetermined amount of time.

In addition to the above, the present invention allows for a much more economical educational resource. A computing device which uses the system of the present invention is a considerably cheaper educational resource than a trained educational professional. With the assistance of a caregiver/parent, the present invention can be used for preparing preschool children to be ready for a more formal school setting. Not only that but the present invention can also be used in lieu of more traditional preschool teaching devices. As an example, preschool-geared physical puzzles can only be used once while the system of the present invention can be used multiple times and can be loaded with newer modules/lessons over time.

The present invention also provides for a much easier skills and knowledge assessment tool to be used with child users, preferably those of preschool age. Assessments of such skills and knowledge can be difficult for preschool children as, generally, they do not have the requisite emotional maturity to properly answer assessment questions. As an example, a preschool child might not answer such questions if the person asking the questions might not be liked by the child. However, since the child will enjoy the games presented by the present invention and since the assessment is continuously being performed as the child completes the tasks/lessons disguised as games, then assessment is comparatively easier.

In a first aspect, the present invention provides a system for providing structured educational content to a user by way of a computing device, the system comprising:
a plurality of groups of modules, each group of modules comprising a plurality of educational modules;
at least one testing module for testing said user's abilities in relation to tasks provided by educational modules in at least one of said groups of modules, each of said groups of modules includes at least one testing module for use by said user with assistance from an adult user, said testing module providing games which test said user's abilities;
   wherein
each educational module is for providing said user with at least one task such that said educational module is completed when said at least one task has been completed by said user, said at least one task being provided to said user as a game;
each group of modules is for use by users of a specific age group and each educational module is for completion by said user at a specific predetermined schedule such that each group of modules is for completion by a specific age of said user, each educational module being provided with learning objectives suitable for a user of said specific age;
said educational content has a predefined learning structure; and
said user is a child younger than five years old.

In a second aspect, the present invention provides a method for providing structured educational material to children, the method comprising:

a) providing a plurality of educational modules to a user, each of said educational modules being for providing at least one task for completion by said user, said at least one task being provided to said user by way of at least one game;

b) associating each of said educational modules with a specific period of development of said user such that each of said educational modules is to be completed by said user during said period of development, each of said educational modules having learning objectives suitable for said period of development;

c) providing at least one testing module for use by said user with assistance from an adult user,

d) testing said user's abilities by way of said at least one testing module, said user's abilities being in relation to tasks provided by said educational modules, said testing module providing games which test said user's abilities,

wherein
said plurality of educational modules is provided to said user by way of a computing device;
said at least one task for completion by said user is completed by said user by interacting with said computing device;
said period of development is associated with a specific age of said user.

In a third aspect, the present invention provides computer readable media having encoded thereon computer readable and computer executable instructions which, when executed, implements a method for providing structured educational material to children, the method comprising:

a) providing a plurality of educational modules to a user, each of said educational modules being for providing at least one task for completion by said user, said at least one task being provided to said user by way of at least one game;

b) associating each of said educational modules with a specific period of development of said user such that each of said educational modules is to be completed by said user during said period of development, each of said educational modules having learning objectives suitable for said period of development;

c) providing at least one testing module for use by said user with assistance from an adult user,

d) testing said user's abilities by way of said at least one testing module, said user's abilities being in relation to tasks provided by said educational modules, said testing module providing games which test said user's abilities,

wherein
said plurality of educational modules is provided to said user by way of a computing device;
said at least one task for completion by said user is completed by said user by interacting with said computing device;
said period of development is associated with a specific age of said user.

### BRIEF DESCRIPTION OF THE DRAWINGS

The embodiments of the present invention will now be described by reference to the following figures, in which identical reference numerals in different figures indicate identical elements and in which:

FIG. 1 is a schematic block diagram of a system according to one aspect of the invention.

### DETAILED DESCRIPTION OF THE INVENTION

Since computers, smart phones and tablet computers have a large penetration into middle and lower income families, an easy-to-follow learning structure can be built digitally, thereby allowing parents to use such a learning structure as a reference curriculum in order to assist their children's intellectual development. The present invention therefore provides for a system which may be used in a computer device assisted or computer-assisted teaching/learning method. Using the system of the present invention, caregivers and/or parents can prepare a child for more formal schooling. The built-in learning structure of the grouped modules as well as the interconnectedness of the various modules relieves the caregiver/parent from determining sequencing of lessons/subjects to teach. As well, the assessment of the user's progress and/or skill/knowledge development is not only built-in but is also enhanced by the use of testing modules. A caregiver/parent can thus assist a child user in learning skills and acquiring knowledge that will be useful in a more formal schooling environment. The child's progress can be tracked and assessed by the caregiver/parent and can be accelerated or slowed down as the caregiver/parent deems suitable. The periodic time structure of the system provides the caregiver/parent a time structure in terms of which module needs to be completed by which time period. In one implementation, a schedule of one module a month is contemplated but other schedules (such as one a week or one every month and a half) are also possible.

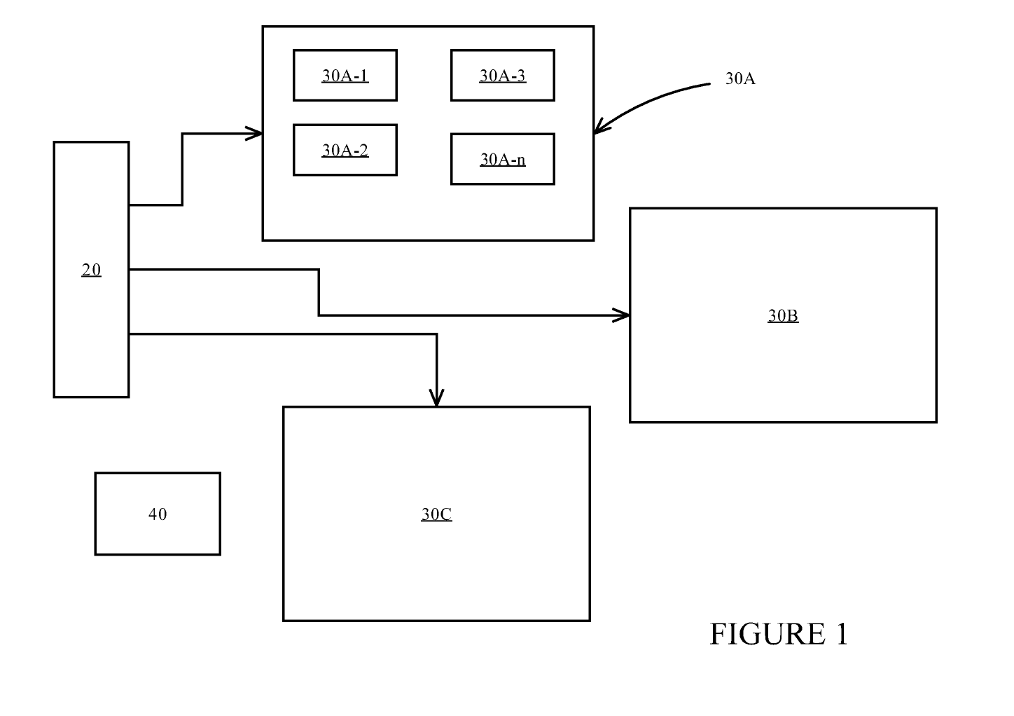

Referring to FIG. 1, a schematic block diagram of a number of educational modules which may be used in the invention is illustrated. As can be seen, the system 10 has a gateway module 20 which is coupled to or communicates with groups 30A, 30B, 30C of educational modules. Each group of educational modules has a number of self-contained educational modules, with each educational module involving at least one activity to be completed by the user. As noted above, the user is preferably a young child ranging in age from at least 6 months to, at most, 5-6 years of age. The educational modules are presented to the user using a computing device as will be described in more detail below.

The gateway module 20 provides the user with a means to access the various educational modules in the system. The gateway module 20 provides a menu so that the user can select which group of educational modules is to be accessed. Once the group of educational modules has been selected, the various educational modules within that group can be accessed and launched. In another implementation, the gateway module provides direct access to the various educational modules to thereby bypass the grouping of the educational modules. Of course, for this implementation, each educational module is still associated with its group.

It should be noted that each group of educational modules is targeted to a specific age group of users. The educational modules in each group are designed to be usable and accessible to the user age range for that group. As an example, group 30A may be for users aged 18 to 30 months old. Group 30B may be for users aged 31 to 42 months old and group 30C may be for users aged 43 to 60 months old. As can be imagined, the accessibility and/or difficulty of the activities involved in the educational modules for the different groups are adjusted with the users' ages in mind. Thus, the activities for the younger users are easier and more accessible than the activities for the older users.

Within each group of educational modules, each educational module is associated with a specific month in the user's age range and each educational module is designed to be completed within that month. As an example, referring to FIG. 1, group 30A has modules 30A-1, 30A-2, 30A-3, . . . 30A-n. Educational module 30A-1 is to be completed at month 18 of the user's age. Module 30A-2 is to be completed at month 19 of the user's age, and module 30A-3 is to be completed by month 20 of the user's age. Thus, in this example, since group 30A is for users aged 18 months to 30 months, there should be at least 12 different modules in the group 30A, with each month in the user's development being represented by at least one educational module. Of course, multiple modules may be present for one month in the user's development. As an example, instead of only one educational module for the 33rd month in a user's development, 3 educational modules may be designated for that month.

Within each group, a testing module may also be present. A testing module, to be completed by the user with assistance from an adult, tests the user's abilities regarding the activities in the educational modules for that group. Thus, if the educational modules in, for example, group 30B had activities involving math or numerical skills, language skills, and social interaction skills, a testing module within the same group may also test those same skills. The testing module may simply have different activities which are copies of the activities in the different educational modules in the specific group. As an example, if a numerical skill activity in the group consists of the user organizing numbers in ascending order, the same activity may be present in the testing module. As another example, if the activity in one of the educational modules in the group involved rearranging 8 tiles to form a tower, the testing module may have the user rearranging 5 tiles to form a similar tower. The testing module activities may therefore include a simple copy of a previously presented activity or they may include a smaller, simpler copy of a previously presented activity.

As noted above, the testing module may need the assistance of an adult. In one possible activity in the testing module, the adult reads a fact situation to the user and presents the user with a number of possible answers. The user then selects from the given possible answers and the adult enters the user's response. Another possible activity involves having the user count items presented by the adult (the items may or may not be presented on the computing device. The adult can then judge the user's performance and enter the result on the computing device. The testing module may, in one configuration, be implemented as an application or “app” that executes on the adult or caregiver's computing device.

A database reporting module 40 may also be present in the system 10. The database reporting module 40 deals with reporting user performance related data to a database. The database stores this user performance related data such that it can be data-mined to determine a user's progress through the modules as well as to determine the user's strengths, shortcomings, and skill and knowledge increase. As noted below, the reporting to the database of this data can be done after every time the user uses one of the educational modules. Alternatively, the reporting may be done after one of the testing modules is used. The database may be stored on the user's computing device or it may be stored remotely. Alternatively, a database with components stored on the user computing device and with components stored remotely may also be used.

It should be noted that the different educational modules need not use conventional scoring or grading to mark a user's completion of the task set out in the different modules. Instead of a score that tracks a level of completion or which ranks success rate for the user, some of the educational modules may use non-traditional awards or incentives for the users. As an example, instead of numerical scoring, completion of an educational module may provide the user with happy images, songs, or access to other activities. As well, completion of a task or a stage of a task may also be rewarded with an emotionally positive indicator. Incorrect responses or incompletion of a task or a stage of a task may be indicated by an emotionally negative indicator. Emotionally positive indicators may be happy songs, happy animations, happy sounds (e.g. laughter, happy sounding music), or positive images (e.g. smiling children, happy looking animals, etc.). Emotionally negative indicators may be scary sounds (e.g. barking dog sounds, angry sounds), frowning images or animations, and loud, unpleasant sounds. The testing modules preferably use more traditional scoring schemes.

The different modules in a group of modules may be organized in a ladder configuration such that higher level modules can only be accessed if lower level modules have been completed. As an example, a level 10 module may only be accessed if all the previous lower level modules have been completed (i.e. levels 0-9). In one configuration, the modules in the ladder configuration are not necessarily all in the same area or field. As an example, to access a science related level 9 module, a user may need to complete level 7 module related to math and a level 8 module related to history. Such a configuration would ensure that a user is given a well-rounded background in various subjects as opposed to being only well-versed in one field. Of course, as an alternative, the modules in a ladder configuration may all be in the same field. For this alternative, to access a level 9 module in history, a user would need to complete level 7 and level 8 modules in history.

It should also be noted that modules in a ladder configuration may all be in the same group. Thus, level 7 and level 8 modules which need to be completed to access level 9 modules may be in the same group as the level 9 modules. Alternatively, the lower level modules may be in a different group from the higher level modules. As an example, the level 7 and level 8 modules which may be needed to access the level 9 modules may be in a group of modules for 18-24 month old children while the level 9 modules may be in a group for 25-36 month old children.

It should further be noted that the various modules and the various tasks for the modules may be interconnected across modules. As an example, a counting task in one module may use animals, icons, or characters introduced in a previously completed module. Or, as another example, a task in one module may require the user to use skills developed in a previous module, e.g. a science related task in one module may require the user to count using counting skills developed in a previous module.

Preferably, the various tasks and modules and the skills and knowledge that they develop in the child user are cumulative towards a specific end goal. The skills and knowledge are, preferably, designed to be cumulative and to prepare the child user for more conventional school learning (i.e. classroom-based learning). To this end, the various tasks can be designed to develop skills that the child user will need in the first few years of conventional schooling. Social skills that involve sharing with others, politeness, tolerance, as well as conflict resolution or avoidance can be developed or at least introduced to the child user using the various modules. Other skills such as letter recognition, number recognition, counting, visual estimation of values, and even rudimentary reading skills can also be introduced and/or developed using the various modules and activities. Knowledge regarding the wider world can also be introduced to and developed in the child user. Various animals, cultures, foods, landmarks, and behaviors and even the history of various peoples can be presented to the child user. Activities highlighting such knowledge can form part of the various modules in the system.

The invention may be practiced using a computing device such as a desktop personal computer or a portable laptop computer. Preferably, the invention is used on a portable computing device such as a tablet computing device, a smartphone, or the like. For ease of access of the user, the device preferably has a touch screen interface so that younger users do not need to learn how to use a more traditional mouse or keyboard interface. A suitable speaker on the device would also be useful. For much younger users, a tablet device designed specifically for young users in mind (such as that disclosed in U.S. patent application Ser. No. 12/892,052 which is incorporated herein by reference) is preferable.

The invention may be implemented as software. A framework software package (or a framework application for tablets and smartphones) can provide the structure for the system with educational modules being added or removed as necessary. Adult users may download additional educational modules as necessary with the educational modules coming in packs such that age specific or subject packs can be downloaded. As an example, an adult user with a 24 month old child can download and install a pack of educational modules specifically designed for children between the ages of 24-36 months. Alternatively, an adult user who wishes his or her child to receive more education in math can download and install a math pack with more math-oriented educational modules.

The educational modules can provides multiple types of activities and tasks for the user. Some of these tasks and activities are as described below. Preferably, the tasks and activities are in the form of games which a young child will enjoy participating in or completing.

In one module, the module provides the user with an image or an animation of a room with multiple colored items. Touching each item activates a voice identification of the item and its color.

In another module, the user is provided with an image or an animation of multiple types of percussion instruments. Touching each instrument in turn activates the sound of the particular instrument. The user can then be presented with a specific rhythm that the user has to replicate with the percussion instruments presented.

A further module presents the user with an image or animation of a kitchen environment. The user can be presented with different items and the user is tasked with selecting which items are edible and which are not. Alternatively, the user may be presented with different groups of items. The user then has to select groups of items which are inedible or which are edible.

Another module presents the user with a farm environment with different scenes, each scene having a different task for the user to complete. The scenes may involve animals, farm produce, and a farm stall with different types of farm product and farm related products. Depending on the scene, the tasks may involve categorizing different items, sorting different groups of items, grouping like things together, and/or counting.

In another module, the user is presented with a facsimile of a musical instrument. In one task, the user is presented with different musical patterns played on the instrument and the user has to match these musical patterns. In another task, the user is presented with one musical pattern and he or she has to select a matching pattern from a group of musical patterns. The patterns may be well-known melodies. In one implementation, the instrument is a piano.

For yet another module, the user is presented with images of differently sized and shaped doors. The user can select colors with which to color the doors. A voiceover which identifies the shape of each door can be activated when the user clicks or activates each door.

In a further module, the user is presented with a zoo or animal habitat environment. The user is presented with various types of baby animals and the user is expected to match the different baby animals with their parents. Also, the user can be presented with various types of animal habitats and the user is expected to match each animal with its preferred habitat.

Another module has the user presented with different ways to represent numbers. Also, the concept of different numbers is also presented by showing, as an example, the same number of different animals and explaining that the different representations are for the same number. The user is then expected to select which representations are for the same number or which are for different numbers.

A further module presents the user with a palette of colors and the user can use the different colors to paint a scene. The equivalent is, using a touchscreen, akin to virtual finger painting.

Another module presents the user with a park environment. The environment provides the user with various activities related to the different areas of the park. As examples, a food vendor area provides activities relating to numbers while a pond area can have activities relating to animal identification, grouping, or other similar activities.

Another educational module may be directed to observational skills which teach the user to observe carefully and consider options before selecting or making a decision. This may involve providing the user for a brief time with a busy animated scene with multiple moving items. The scene is then removed and the user is asked a very specific question about the scene.

Other educational modules may be directed towards multicultural ideas and acceptance of multicultural concepts. The user is presented with various environments showcasing different cultures and activation of different items in the environment activates audio-visual presentations explaining an aspect of the culture being showcased. The highlighted cultural aspects may include cuisine, dress, traditions, history, and customs. These activities may require the assistance of the user's parents or adult guardians or caregivers.

Further educational modules can be focussed on world geography and landmarks. The user can be presented with various maps of regions or continents. Activating a region can activate activities or presentations explaining the region, its culture, landmarks, indigenous animals, and history. Landmarks, such as the Petronas Towers, the Space Needle, the CN Tower, the Tower of London, Big Ben, etc. can be the subject of simple jigsaw puzzles or fill in the blank/missing section puzzles.

Other educational modules are directed towards developing appropriate social interaction skills. The user can be presented with an animated or a still image situation with an audio explanation of the situation which has a social interaction component. The user is then provided with a number of potential actions which the user can take. The user then has to select an appropriate social response to the situation. The activity may require interaction with and assistance of an adult parent, guardian, or caregiver. Of course, for younger users, the social situation presented are of the very simply type while much more complex social situations may be presented for older users.

Other modules may present the user with activities relating to:
number identification;
shape identification and differentiation;
visual pattern recognition;
identification and location of various human body parts;
identification of various animals and differentiation between these animals including their habitats and habits;
number sense including counting, different representations of numbers and simple arithmetic operations including addition and subtraction as well as activities which teach the user about qualitative math including the concepts of near, far, many, and few;
sequences and organizing items into a proper numerical, temporal, or organizational sequence;
recognizing absurd situations and having the user point out the absurdity of the situation;
relative weights such as having the user determine which of multiple items are heavier or lighter than the others.

The various educational modules may be implemented as being independent from one another. Furthermore, they may be implemented as modules which can be added to the system as necessary or as desired. The system may therefore have a gateway module and only a number of groups of educational modules. Other groups may be added to the system as a user's adult guardians or parents desire. Alternatively, instead of adding groups of modules, educational modules may be added to a group, thereby extending the number of modules in a group. Depending on the configuration, additional educational modules or additional groups of educational modules may be downloaded to the computing device and added to the system. Educational modules may be downloaded and added separately or they may be added as part of an additional group. As an example, the system may initially be configured with the gateway module and a group of educational modules specifically designed for users between the ages of 18 months to 30 months. Once the user has reached the 30 month mark, the user's parents may decide to extend the capabilities of the system by downloading and installing a second group of educational modules. The second group of educational modules may be geared for users between the ages of 31 months and 42 months. The user can then start using the second group of educational modules.

After each module is completed, the performance of the user on completing or attempting to complete the module can be stored in a database. The database can be stored on the computing device on which the modules are executed. Alternatively, the database can be stored on a server remote from the user's computing device. A database reporting module may be present in the system such that data relating to the user's performance when using a module can be reported to the database (whether remote or on the user's computing device) by the data reporting module. In one configuration, each time a user uses his or her computing device to complete or attempt to complete a module, the results are stored on the computing device or uploaded to a server that stores the user's performance data. The user's performance data can take the form of how many times the user attempted to complete a module, how many correct answers the user entered, how many errors the user committed in the module, how long the user took to complete the module, as well as the type of errors the user committed. The user's performance data can also include which types of questions the user was able to answer correctly, which questions were answered incorrectly, the concepts which were correctly learned, as well as the concepts which may not have been correctly learned. Furthermore, the user's performance data can also include the types of mistakes the user made. The reasons why the user's response is considered incorrect can also be part of the user's performance data.

Regarding the implementation of the database noted above, the reasons for a user's incorrect responses can be based on database entries. The reasons can be predetermined and can be associated with specific responses from the user based on the module being attempted. As an example, for each possible response from the user for a specific question in a module, a specific reason can be assigned with that specific reason being entered into the user's performance data based on which response the user entered. As an example, in one configuration, a module's question has 3 possible wrong responses and each wrong response is associated with a specific reason as to why the response is wrong. If the user selects one of these wrong responses, that wrong response's associated reason for being wrong is entered in the user's performance data.

The database which stores the user's performance data can be configured so that every time the user uses a module, the user's performance data is stored on the user's computing device for later uploading or is automatically uploaded to the database once the data is available. Thus, the database can contain data for all of the user's interactions with all of the modules in the system. The database can thus be mined for information as to the user's progress throughout the modules as well as the user's strengths and weaknesses as shown by his or her performance in using the modules.

To assist in the tracking of the user's learning progress, a caregiver or adult tasked with determining the user's progress through the modules may be given access to the database noted above. The access to the database may be through a specific application executed on the user's computing device or through the caregiver/adult's own computing device. Once access is given, the application can show the caregiver/adult the user's progress, the user's strengths and weaknesses (e.g. which modules the user performed well in, which modules the user did not perform well in, the tasks which the user completed quickly, the tasks which the user did not complete, and tasks which the user did not complete quickly) as well as areas in which the user needs improvement on or can improve on. The format of the interface for the caregiver/adult's access to the database can be implementation dependent. In one configuration, the caregiver/adult uses an application on the user's computing device to access the database. In another configuration, the caregiver/adult is given access to the database using their own computing device.

The structured learning approach embodied by the predetermined module completion schedule can be used by the child user's parents or caregivers to guide the user's development. Since each module builds on previous modules and since the user's progress on the system as a whole can be tracked, the caregiver/parent can track the user's development and progress. Also, instead of wondering which subject should be developed next, caregivers and parents are provided with a predetermined educational framework that they simply have to follow with the user. Essentially, the caregiver/parent merely has to control how often/how fast the user uses the system. As an example, the system may be designed to have one module completed per month. However, if a caregiver/parent determines that the user is already quite advanced, then the user may be allowed to complete more than one module per month, thereby accelerating the user's mental and knowledge development.

In addition to the above, the use of the system of the invention allows caregivers/parents flexibility in terms of the timing and location of lessons for the user. As an example, instead of a more formalized school atmosphere, lessons can be provided to the child user in an informal setting such as at home or on the road. The child user thus does not have any added pressure to learn and perform that other children are under when they're in a more formalized learning environment. Furthermore, using the database described above, the computer assisted learning allows for ease of tracking of the user's progress along with which lessons or modules have been completed by the user.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g.“C”) or an object oriented language (e.g.“C++”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A system for providing structured educational content to a user by way of a computing device, the system comprising:
a plurality of groups of modules, each group of modules comprising a plurality of educational modules;
at least one testing module for testing said user's abilities in relation to tasks provided by educational modules in at least one of said groups of modules, each of said groups of modules includes at least one testing module for use by said user with assistance from an adult user, said testing module providing games which test said user's abilities;
wherein
each educational module is for providing said user with at least one task such that said educational module is completed when said at least one task has been completed by said user, said at least one task being provided to said user as a game;
each group of modules is for use by users of a specific age group and each educational module is for completion by said user at a specific predetermined schedule such that each group of modules is for completion by a specific age of said user, each educational module being provided with learning objectives suitable for a user of said specific age;
said educational content has a predefined learning structure; and
said user is a child younger than five years old.

2. A system according to claim 1 wherein said at least one task provided to said user by said educational module relates to at least one of:
mathematics,
language skills,
social skills, and
cultural awareness.

3. A system according to claim 1 wherein said predetermined specific schedule comprises completing at least one module every month.

4. A system according to claim 1 wherein said plurality of groups of modules includes a group of modules directed at users having an age selected from:
between 18 and 30 months of age;
between 31 and 42 months of age; and
between 43 and 60 months of age.

5. A system according to claim 1 further including a database reporting module for reporting data related to said user's performance to a database, said data being gathered after said user uses one of said educational modules.

6. A system according to claim 5 wherein said database is accessible to said adult user such that said adult user can track a user's progress through said educational modules.

7. A system according to claim 1 wherein at least one of said educational modules rewards said user with emotionally positive indicators for successful completion of a task.

8. A system according to claim 1 wherein at least one of said educational modules provides said user with emotionally negative indicators in the event said user enters an incorrect response for said at least one task.

9. A system according to claim 1 wherein, for each group of modules, said modules are configured in a ladder configuration such that higher level modules are only accessible after lower level modules have been completed.

10. A system according to claim 9 wherein said lower level modules are in a different group from said higher level modules.

11. A system according to claim 9 wherein said lower level modules are in a same group as said higher level modules.

12. A system according to claim 1 wherein performance data for said child user's performance when using said modules is stored in a database every time at least one of said modules is used.

13. A method for providing structured educational material to children, the method comprising:
a) providing a plurality of educational modules to a user, each of said educational modules being for providing at least one task for completion by said user, said at least one task being provided to said user by way of at least one game;
b) associating each of said educational modules with a specific period of development of said user such that each of said educational modules is to be completed by said user during said period of development, each of said educational modules having learning objectives suitable for said period of development;
c) providing at least one testing module for use by said user with assistance from an adult user,
d) testing said user's abilities by way of said at least one testing module, said user's abilities being in relation to tasks provided by said educational modules, said testing module providing games which test said user's abilities,
wherein
said plurality of educational modules is provided to said user by way of a computing device;
said at least one task for completion by said user is completed by said user by interacting with said computing device;
said period of development is associated with a specific age of said user.

14. A method according to claim 13 wherein said period of development is a specific month in said age of said user.

15. A method according to claim 13 wherein said method further comprises reporting data relating to said user's performance after said user uses at least one educational module, said data being sent to a database.

16. A method according to claim 13 wherein said at least one task provided to said user relates to at least one of:
mathematics,
language skills,
social skills, and
cultural awareness.

17. A method according to claim 13 wherein said plurality of educational modules is organized into groups of modules and each group of modules is for use by users of a specific age group.

18. A method according to claim 13 wherein each educational module is for completion by said user at a specific monthly age of said user such that each group of modules is for completion by a specific age of said user.

19. Computer readable media having encoded thereon computer readable and computer executable instructions which, when executed, implements a method for providing structured educational material to children, the method comprising:
a) providing a plurality of educational modules to a user, each of said educational modules being for providing at least one task for completion by said user, said at least one task being provided to said user by way of at least one game;
b) associating each of said educational modules with a specific period of development of said user such that each of said educational modules is to be completed by said user during said period of development, each of said educational modules having learning objectives suitable for said period of development;
c) providing at least one testing module for use by said user with assistance from an adult user,
d) testing said user's abilities by way of said at least one testing module, said user's abilities being in relation to tasks provided by said educational modules, said testing module providing games which test said user's abilities,
wherein
said plurality of educational modules is provided to said user by way of a computing device;
said at least one task for completion by said user is completed by said user by interacting with said computing device;
said period of development is associated with a specific age of said user.

20. Computer-readable media according to claim 19 wherein said method further comprises reporting data relating to said user's performance after said user uses at least one educational module, said data being sent to a database.
